(19) United States
(12) Patent Application Publication
(10) Pub. No.: US 2006/0067822 A1
(43) Pub. Date: Mar. 30, 2006

(54) Pitch lock and lag positioner for a rotor blade folding system

(76) Inventor: Frank Paul D'Anna, Seymour, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/950,126

(22) Filed: Sep. 24, 2004

(51) Int. Cl. B64C 27/54

(52) U.S. Cl. 416/98

(57) ABSTRACT

A rotor blade folding system includes a blade lock assembly, a rotary actuator and a blade fold controller to selectively position each rotor blade assembly in a particular predetermined folded position. The blade lock assembly positions each blade yoke in a predetermined lead/lag and pitch position to minimize strain upon an elastomeric bearing between the blade yoke and the rotor hub. The rotor blade is then folded relative to the blade yoke to a predetermined blade fold angle.

### BACKGROUND OF THE INVENTION

The present invention relates to a blade fold system for a helicopter, and more particularly to a rotor blade positioning system which positions each rotor blade prior to blade folding while minimizing applied strain to elastomeric bearings within the rotor head.

While the flight capabilities of helicopters makes them effective vehicles for a wide variety of missions, operation of helicopters in certain circumstances may be limited by the overall structural envelopes thereof. The large radial dimensions of helicopter rotor assemblies results in helicopters having relatively large structural envelopes, which may limit their utility in some circumstances.

Helicopters, particularly military helicopters utilized for maritime flight operations, may be required to conduct operations from ships for extended periods of time. Shipboard space is generally at a premium, and the large structural envelopes of helicopters means that stowage during periods of non-use requires a relatively significant allocation of such limited space. Furthermore, strategic and tactical considerations in the military utilization of helicopters has led to a requirement for helicopters having main rotor assemblies that may be readily reconfigured for rapid deployment, routine transport, and/or stowage through reduction in structural envelopes.

Several options are available to reduce the structural envelopes of helicopters to facilitate rapid deployment, routine transport, stowage, and/or to reduce the vulnerability thereof to environmental conditions. One option is to design the main rotor assemblies thereof so that the main rotor blades may be folded about the main rotor hub assembly. Main rotor blade folding operations are typically implemented automatically.

One helicopter with an automatic blade folding system is the CH-53E. The CH-53E is currently the world's largest shipboard compatible helicopter. A significant consideration in the design of the CH-53E is shipboard compatibility. The CH-53E in a stored configuration effectively defines the maximum structural envelope which will fit on the elevators and in the hangar deck of United States Marine Corps Amphibious Assault Ships.

Prior to folding blades on any helicopter the blades must be located and locked in a pre-set blade fold position such that a blade hinge axis is oriented to allow folding of each blade to its proper folded position. On aircraft such as CH-53E, blade positioning is accomplished using a series of hydraulic actuators and stops. The current CH-53E rotor head utilizes a hydraulic actuated piston incorporated into the damper as a pitch lock. Accumulator pressure drives the damper to hold the blade in the pre-set blade fold position in which the yoke is driven to full lag or lead position. The swashplate is then located in a pre-set position such that each blade is at the correct pitch angle for the blade pitch locks to engage. Since pitch motion occurs between the sleeve and the spindle, a hydraulic actuated pin on the sleeve engages a lug on the spindle to lock the spindle and sleeve together to prevent pitch motion. These components function independently as the current CH-53E rotor head employs separate conventional bearings for pitch, flap, and lead/lag blade motions.

Elastomeric rotor heads with elastomeric bearings provide numerous advantages over conventional rotor head assemblies which utilize separate bearings for pitch, flap, and lead/lag blade motions. Elastomeric rotor heads provide such significant advantages, that current aircraft such as the CH-53E may be modernized to include an elastomeric rotor head.

Current blade folding systems are not transferable to an elastomeric rotor head as the elastomeric bearings and visco-elastic damper are essentially springs which are always biased toward a predetermined position. Deflection away from the predetermined position strains the elastomeric bearings and visco-elastic damper. Significant deflection over prolonged timer periods, such as during a blade fold position, may eventually damage the elastomeric rotor head system.

Accordingly, it is desirable to provide a blade folding system for an elastomeric rotor head system which positions each rotor blade prior to blade folding while minimizing applied strain to elastomeric bearings within the rotor head.

### SUMMARY OF THE INVENTION

The rotor blade folding system according to the present invention generally includes a blade lock assembly, a rotary actuator and a blade fold controller to selectively position each rotor blade assembly in a particular predetermined folded position. The blade lock assembly positions each yoke in a predetermined lead/lag and pitch position and a predetermined rotor blade fold angle.

In operation, an electric motor drives a planetary gear train to sequentially extend a lag lock pin into a tapered lag lock bushing formed in the yoke to locate the yoke in a predetermined lead/lag fold position. The lag lock pin continues to extend along a lag lock pin axis until fully seated within a lag lock bushing. Once the lag lock pin is fully seated, one planetary gear train gear is locked to drive a pitch lock pin along a pitch lock axis into a pitch lock bushing mounted within the yoke to locate the yoke in a predetermined pitch fold position. Once each yoke is locked in the blade fold position, the blade fold controller drives the rotary actuator to rotate each rotor blade to a predetermined blade fold angle.

To unfold the blades, the blade fold controller reverses the rotary actuator to return the rotor blade to a flight position and reverses the electric motor to retract the pins such that the yoke returns to a flight configuration defined by the elastomeric bearings.

The present invention therefore provides a blade folding system for an elastomeric rotor head system which positions each rotor blade prior to blade folding while minimizing applied stress to elastomeric bearings within the rotor head.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general perspective view an exemplary rotary wing aircraft embodiment for use with the present invention with a main rotor assembly in a flight position;

FIG. 2 is a top plan view of a main rotor assembly illustrating a single blade and blade fold system;

FIG. 3 is a general perspective view of an exemplary rotary wing aircraft embodiment for use with the present invention with a main rotor assembly in a folded position;

FIG. 4 is a top plan view of a main rotor assembly illustrating the rotor blades in a folded position;

FIG. 5 is a top expanded plan view of a main rotor assembly illustrating three blades in the folded position;

FIG. 6A is a top expanded partial section plan view of a blade lock assembly in an unlocked position;

FIG. 6B is a top expanded partial section plan view of a blade lock assembly as the lag lock pin is being driven toward a lock position;

FIG. 6C is a top expanded partial section plan view of a blade lock assembly with the lag lock pin in a lock position and a pitch lock pin being driven toward a lock position;

FIG. 6D is a top expanded partial section plan view of a blade lock assembly in an locked position; and

FIG. 7 is an expanded side perspective view of a main rotor assembly illustrating the rotor blades folded relative a blade yoke.

### DETAILED DESCRIPTION OF THE PREFERRED EMBODIMENT

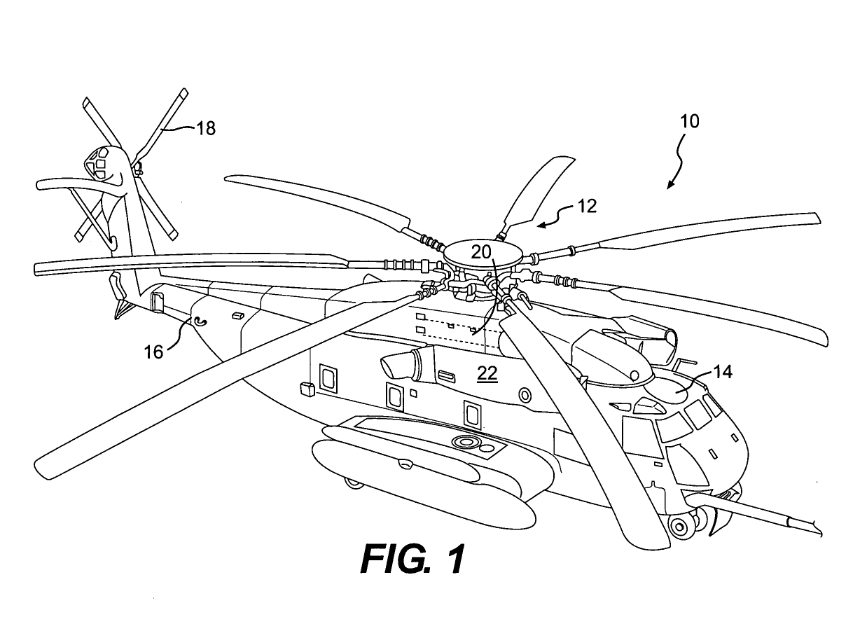

FIG. 1 schematically illustrates a rotary-wing aircraft 10 having a main rotor assembly 12. The aircraft 10 includes an airframe 14 having an extending tail 16 which mounts an anti-torque rotor 18. The main rotor assembly 12 is driven through a transmission (illustrated schematically at 20) by one or more engines 22. Although the present invention is described hereinbelow in terms of the particular structural features of the main rotor assembly 12 of a Sikorsky CH-53 helicopter configuration as illustrated in the disclosed embodiment, it should be understood that the present invention may be modified for use with rotor assemblies of other helicopters, turbo-props, tilt-rotor aircraft and other elastomeric bearing based rotor assemblies.

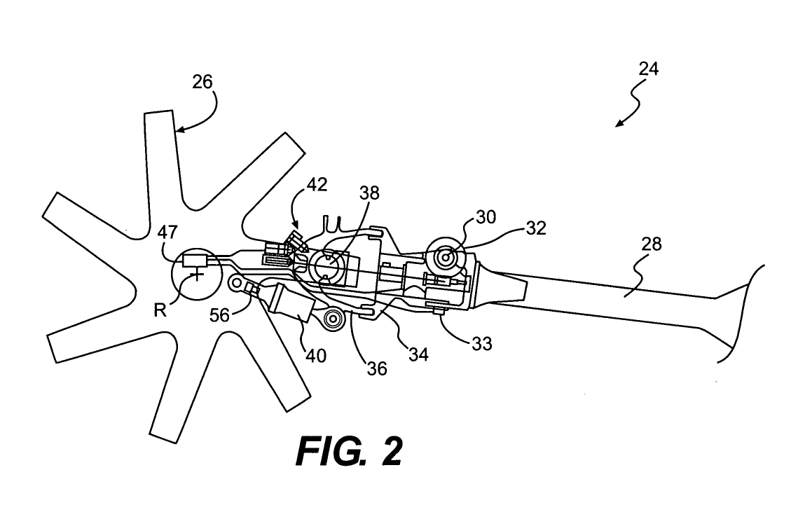

Referring to FIG. 2, the rotor assembly 12 includes seven rotor blade assemblies 24 (one shown) each mounted to a rotor hub 26 which rotates about an axis of rotation R. Each rotor blade assembly 24 includes a rotor blade 28, a hinge assembly 30, a rotary actuator 32, a sleeve 34, a yoke 36 an elastomeric bearing 38, a damper assembly 40 and a blade lock assembly 42. The yoke 36 is mounted to the rotor hub 26 through the elastomeric bearing 38 such that the blade assembly 24 may be moved in flapping, pitch and lead/lag motions as generally understood. The damper assembly 40 reacts against lead/lag motions of the blade assembly 24 and serves to dampen vibration.

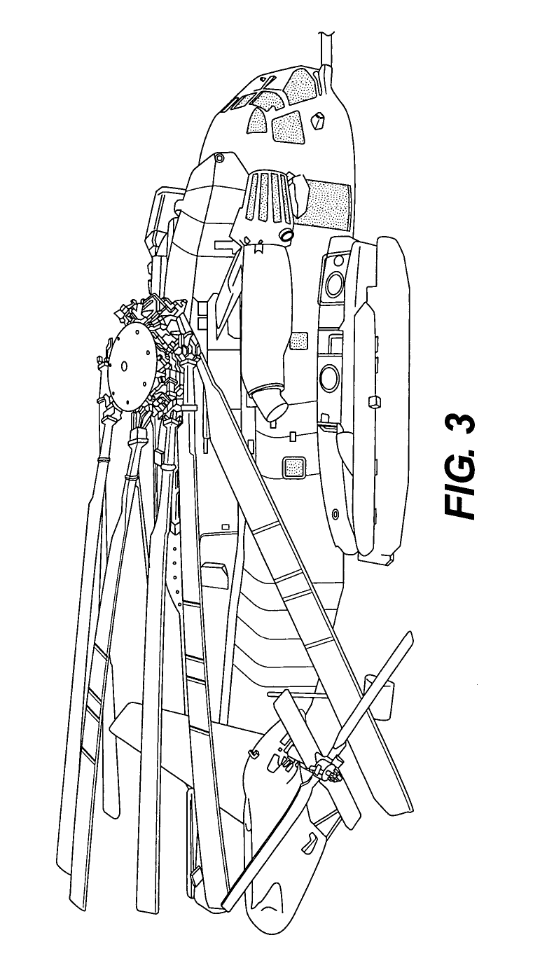

A rotor blade folding system 44 generally includes the pitch lock assembly 42, the rotary actuator 32, a retractable blade retaining pin 33 and a blade fold controller 47 (illustrated schematically) to selectively position each rotor blade assembly 24 in a particular folded position to minimize the aircraft structural envelope (FIG. 3).

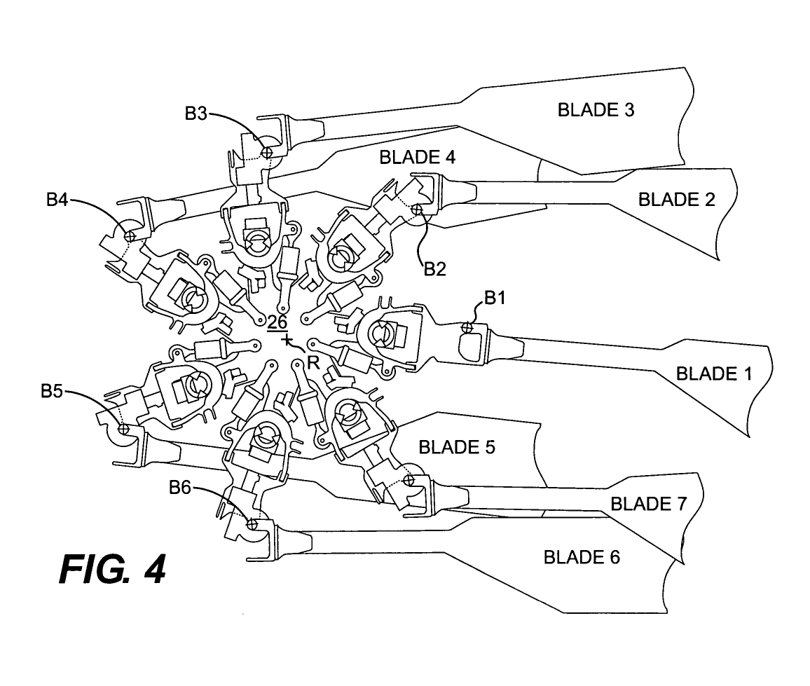

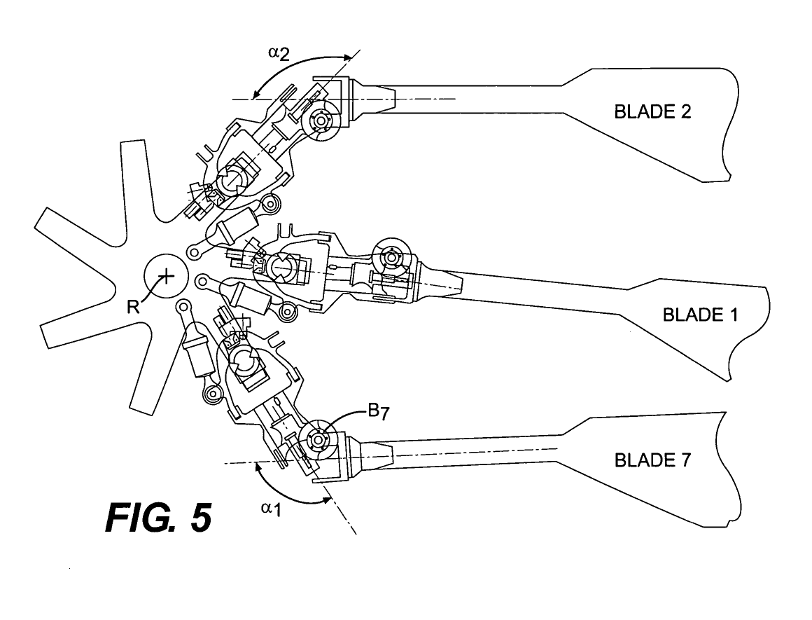

Referring to FIG. 4, the blade lock assembly 42 is mounted to the rotor hub 26 and selectively engages the yoke 36. The blade lock assembly 42 positions each blade assembly 24 in its blade fold position which includes positioning each yoke 36 in a predetermined lead/lag and pitch position and a predetermined rotor blade fold angle. Once the pitch lock assembly 42 engages the yoke 36, the rotary actuator 32 rotates each rotor blade 28 to a predetermined blade fold angle ∝₁-∝₇ about a blade fold pivot axis B₁-B₇ (also illustrated with only blades 1, 2 and 7 in FIG. 5). Notably, minimal strain is placed on the elastomeric bearing 38 as the pitch lock assembly 42 locks each yoke 36 to the rotor hub 26.

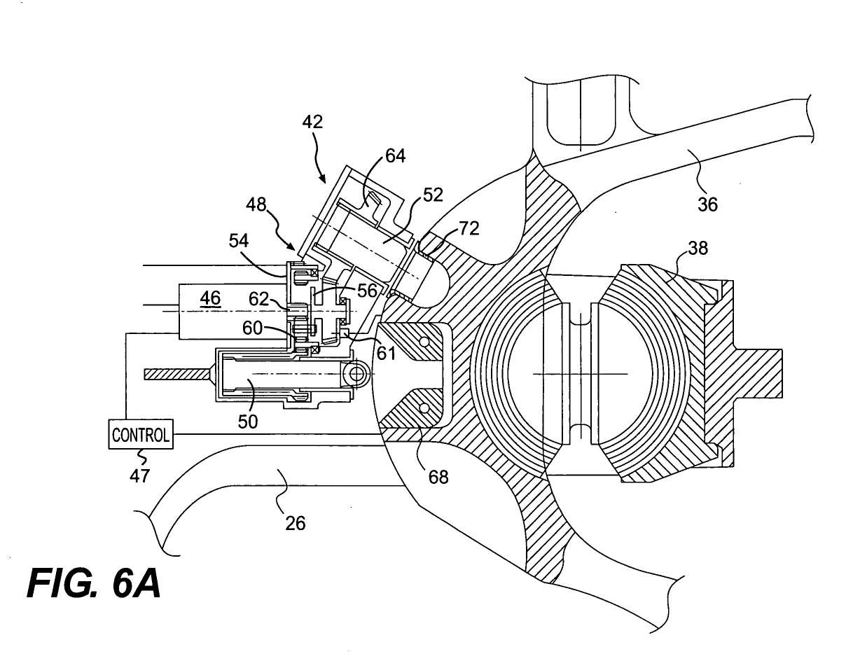

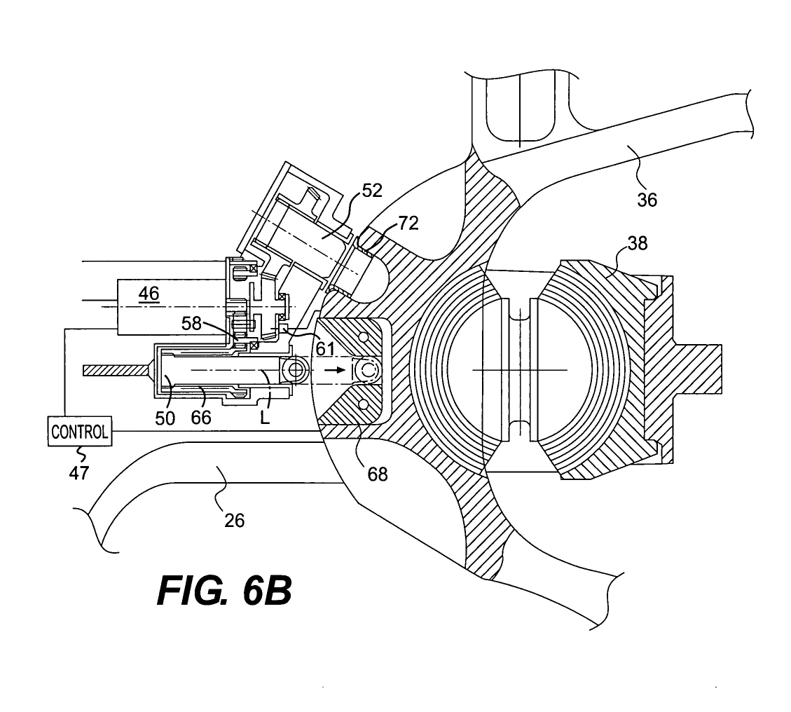

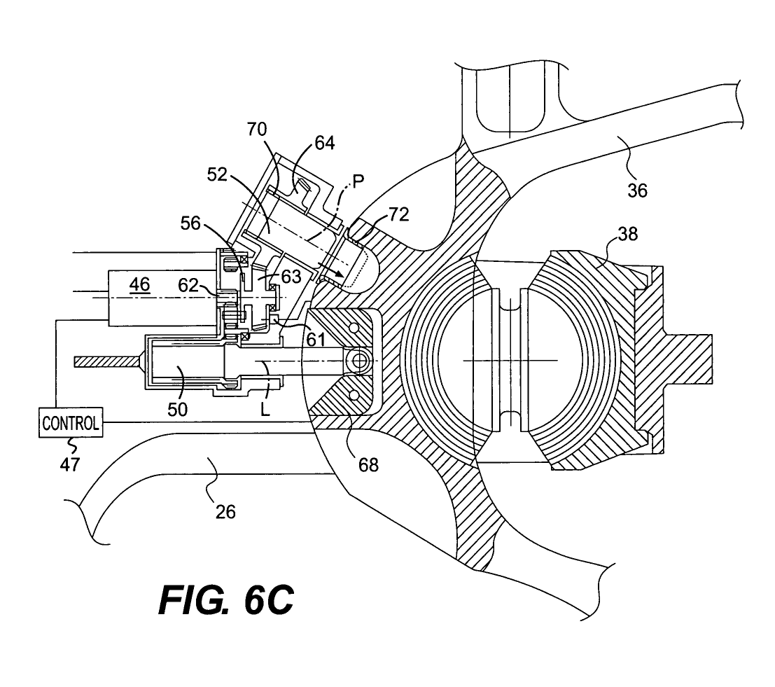

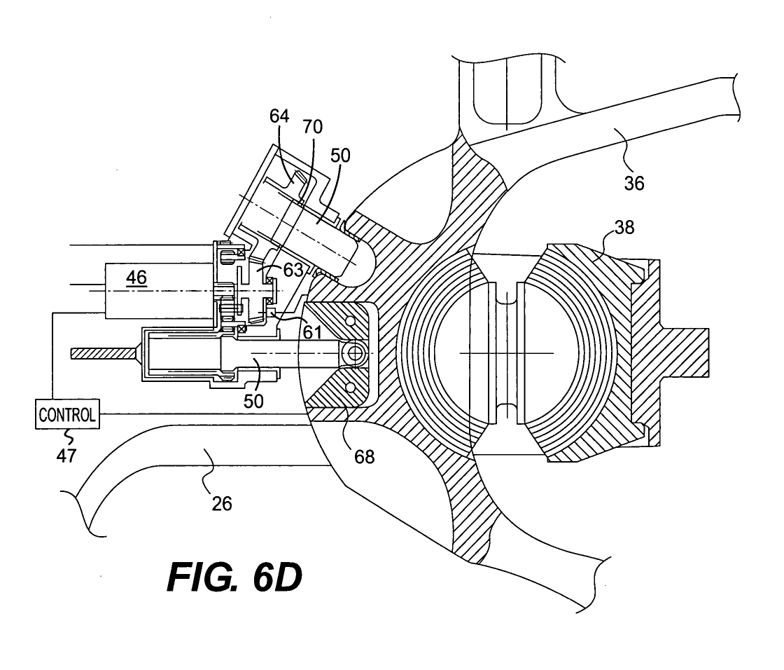

Referring to FIG. 6A, the pitch lock assembly 42 includes an electric motor 46 which drives a gear train 48 to drive a lag lock pin 50 and a pitch lock pin 52. The gear train 48 preferably includes a planetary gear train 54 which sequentially drives the pins 50, 52. The planetary gear train 54 includes a planet carrier 56, a ring gear 58 and a multiple of planet gears 60. The electric motor 46 includes an output shaft 62 in meshing engagement with the plant gears 60 to selectively drive two outputs. A first output is the planet carrier 56 when the ring gear 58 is locked. A second output is the ring gear 58 when the planet carrier 56 is locked.

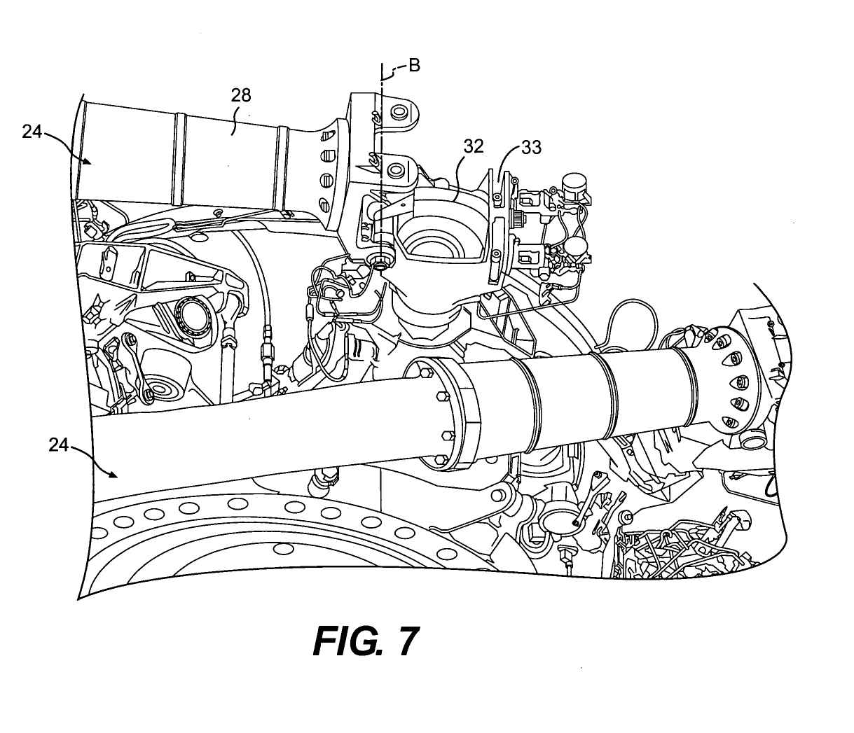

In operation, the electric motor 46 drives the output shaft 62 which is meshing engagement with the planet gears 60. The planet carrier 56 remains rotationally stationary due to a detent pin 61 engaged therewith. The detent pin 61 is preferably a solenoid-actuated pin controlled by the blade lock controller 47. It should be understood that other anti-rotation devices may also be used to provide the selective output with which to drive the pins 50, 52. The planet gears 60 rotates the ring gear 58 which drives a lag pin jack screw 66 to extend the lag lock pin 50 along a lag lock pin axis L. The lag lock pin 50 extends into a tapered lag lock bushing 68 formed in the yoke 36. The lag lock pin 50 continues to extend along the lag lock pin axis L until fully seated within the lag lock bushing 68 (FIG. 6B). Preferably, the lag lock bushing 68 is tapered such that the lag lock pin 50 is funneled into the lag lock busing 68. The interface of the lag lock pin 50 and lag lock bushing 68 drives the yoke 36 into a predetermined lag fold position. The predetermined lag fold position minimizes strain on the elastomeric bearing when the blade is folded (FIG. 7).

Referring to FIG. 6C, once the lag lock pin 50 is fully seated, the ring gear 58 stops, the blade fold controller 47 retracts the detent pin 61, and the planet carrier 56 is then free to turn. The electric motor 46 continues to drive the output shaft 62 which is meshing engagement with the planet gears 60. As the ring gear 58 is essentially locked due to the lag lock pin 50 being fully seated within the lag lock bushing 68, the planet carrier 56 gear rotates a planet carrier gear 63 mounted therein. The planet carrier gear 63 is in meshing engagement with a pitch lock gear 64 to drive a pitch lock jackscrew 70. The pitch lock gear 64 is located along a pitch lock axis P which is preferably non-parallel to the lock pin axis L. The pitch lock jackscrew 70 drives the pitch lock pin 52 along the pitch lock axis P into a pitch lock bushing 72 mounted within the yoke 36 to locate the yoke 36 in a predetermined pitch fold position. As the lag lock pin 50 has previously locked and positioned the yoke 36 to the predetermined blade fold lag position, the pitch lock pin 52 need only position the yoke 36 in pitch. That is, the pitch lock pin 52 overcomes the resistance of the elastomeric bearing 38 in pitch only.

Each rotor blade assembly 24 may be positioned in pitch by articulating the swashplate prior to seating the pitch lock pin 52 along the pitch lock axis P into a pitch lock bushing 72. That is, the pitch lock pin 52 does not specifically pitch the rotor blade assembly 24 during seating but lock the yoke 36 in the blade fold position which the yoke has previously been articulated to by the swashplate. When the swashplate is positioned properly, all the blades 28 are at the correct pitch angle for the blade pitch lock assembly 42 to engage. Separately, the blade fold pivot axis B (FIGS. 3 and 6) for each blade 28 is typically at a different angle, pitch wise, from a fixed point on the yoke 36, such as the blade pitch lock assembly 42. The angle between the blade fold pivot axis B and the yoke 36 center plane is different for each blade assembly 24. This is typically accomplished by creating different sleeves and hinges for each blade assembly 28 such that the forward blades can fold generally under the rearward blades.

Once both pins 50, 52 are fully seated, the blade fold controller 47 stops the electric motor 46 through communication with a sensor such as a limit switch or the like such that each yoke 36 is positioned for blade 28 fold. Once each yoke 36 is positioned for blade 28 fold, the controller 47 drives the rotary actuator 32 to rotate each rotor blade 28 to a predetermined blade fold angle about the blade fold pivot axis B (FIGS. 3, 4, and 7).

To unfold the blades, the blade fold controller 47 reverses the rotary actuator 32 to unfold the rotor blades 28 (∝ to zero) then retracts the pins 50, 52, such that the yoke 36 returns to a flight configuration defined by the elastomeric bearing 38 neutral position.

It should be understood that relative positional terms such as “forward,” “aft,” “upper,” “lower,” “above,” “below,” and the like are with reference to the normal operational attitude of the vehicle and should not be considered otherwise limiting.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A blade lock assembly for rotor blade assembly comprising:
an electric motor;
a gear train in meshing engagement with said electric motor;
a lag lock pin in meshing engagement with said gear train; and
a pitch lock pin in meshing engagement with said gear train.

2. The blade lock assembly as recited in claim 1, wherein said lag lock pin and said pitch lock pin engage a blade yoke to position said blade yoke in a blade fold position.

3. The blade lock assembly as recited in claim 1, wherein said lag lock pin engages a tapered lag lock bushing mounted within a blade yoke.

4. The blade lock assembly as recited in claim 1, wherein said lag lock pin is non-parallel to said pitch lock pin.

5. The blade lock assembly as recited in claim 1, wherein said gear train includes a planet carrier in meshing engagement with a ring gear, said ring gear in meshing engagement with a lag pin jack screw to drive said lag lock pin when said planet carrier is locked

6. The blade lock assembly as recited in claim 5, wherein said planet carrier is locked by a detent pin in response to a blade fold controller.

7. The blade lock assembly as recited in claim 1, wherein said gear train includes a planet carrier in meshing engagement with a ring gear, said planet carrier in meshing engagement with a pitch lock jackscrew to drive said pitch lock pin when said ring gear is locked.

8. The blade lock assembly as recited in claim 7, wherein said ring gear is locked by engagement of said lag lock pin with a lag lock bushing mounted within a blade yoke.

9. The blade lock assembly as recited in claim 8, wherein said ring gear is locked by engagement of said lag lock pin with said lag lock bushing when said lag lock pin has bottomed out within said lag lock bushing along a lag lock pin axis.

10. A rotor blade assembly comprising:
a rotor hub;
a yoke mounted to said rotor hub through an elastomeric bearing;
an electric motor mounted to said rotor hub;
a planetary gear train in meshing engagement with said electric motor;
a lag lock pin in meshing engagement with said gear train, said lag lock pin selectively engageable with said yoke to locate said yoke in a blade fold position; and
a pitch lock pin in meshing engagement with said gear train, said pitch lock pin engageable with aid yoke in response to engagement of said lag lock pin with said yoke to locate said yoke in said blade fold position.

11. The rotor blade assembly as recited in claim 10, wherein said planetary gear train includes a planet carrier in meshing engagement with a ring gear, said ring gear in meshing engagement with a lag pin jack screw to drive said lag lock pin when said planet carrier is locked

12. The rotor blade assembly as recited in claim 11, wherein said planet carrier is locked by a detent pin in response to a blade fold controller.

13. The rotor blade assembly as recited in claim 12, wherein said ring gear is locked by engagement of said lag lock pin with a lag lock bushing mounted within said yoke when said lag lock pin has bottomed out within said lag lock bushing along a lag lock pin axis.

14. The rotor blade assembly as recited in claim 13, wherein said lag lock bushing is tapered.

15. The rotor blade assembly as recited in claim 10, further comprising a rotary actuator to a rotor blade about a blade fold pivot relative to said yoke.

16. A method of folding a rotor blade comprising the steps of:
(1) driving an electric motor to engage a lag lock pin with a tapered lag lock bushing mounted within a blade yoke to overcome an elastomeric bearing between the rotor blade hub and the blade yoke;
(2) driving the electric motor to sequentially engage a pitch lock pin with the blade yoke to overcome the elastomeric bearing in response to engagement of the lag lock pin with the tapered lag lock bushing; and
(3) folding a rotor blade to a predetermined blade fold angle about a blade fold pivot axis.

17. A method as recited in claim 16, wherein said step (1) further comprises driving the lag lock pin with a planetary gear train with a first planetary gear train gear in a rotationally locked position.

18. A method as recited in claim 17, wherein said step (2) further comprises sequentially driving the pitch lock pin with a second planetary gear train gear in a rotationally locked position.

19. A method as recited in claim 16, wherein said step (2) is subsequent to said step (1).
